(19) United States
(12) Patent Application Publication
(10) Pub. No.: US 2012/0078831 A1
(43) Pub. Date: Mar. 29, 2012

(54) BREAST IMPLANT SURGICAL DECISION SUPPORT SYSTEM AND METHOD

(75) Inventor: Benjamin J. Newcott, Costa Mesa, CA (US)

(73) Assignee: ALLERGAN, INC., Irvine, CA (US)

(21) Appl. No.: 13/246,546

(22) Filed: Sep. 27, 2011

Related U.S. Application Data
(60) Provisional application No. 61/387,371, filed on Sep. 28, 2010.

(51) Int. Cl. G06F 17/00

(52) U.S. Cl. 706/46

(57) ABSTRACT

Computer-assisted planning of breast implant surgery apparatus and methods are provided which generally include an anatomical input module configured to receive anatomical information indicative of pre-implant anatomical properties of a patient's breast, a preference module configured to receive preference information indicative of a desired post-implant anatomical property of a patent's breast, a tissue expander selection module configured to receive the anatomical and the preference information, and, based at least in part on the anatomical and preference information, to output recommended expander information indicating at least one tissue expander from an available plurality of tissue expanders, and an implant selection module configured to receive the anatomical and the preference information, and, based at least in part on the anatomical and preference information, to output recommended implant recommendation information indicating at least one implant from an available plurality of implants.

### CROSS-REFERENCE TO RELATED APPLICATIONS

This application claims priority to U.S. patent application Ser. No. 61/387,371, filed Sep. 28, 2010, the entire of disclosure of which is incorporated herein by this reference.

### FIELD OF INVENTION

The present invention relates in general to plastic surgery techniques and in particular to systems and methods for facilitating the selection of appropriate breast implant and tissue expander devices prior to breast augmentation surgery or reconstructive breast surgery.

### BACKGROUND

Breast augmentation is one of the most common cosmetic surgical procedures performed in the United States and Europe. In 2006, almost 400,000 women in the United States chose breast implantation surgery to meet their personal goals. Breast augmentation is, for example, often chosen for enhancing figure proportions, for remedying breast droop or sag due to age, nursing, or weight loss, or for symmetry correction during breast reconstruction after cancer surgery. Studies have also shown that breast augmentation can lead to an improved quality of life. Whatever the reason chosen for breast augmentation, the choice of the appropriate breast implant is the first crucial step in the process of realizing the patient's goals.

Each woman who elects breast augmentation surgery not only has her own personal expectations, but also her own unique set of physical characteristics. Certainly the patient and the doctor must consider the patient's desired post-operative breast size and profile; however, the physical characteristics of the patient's breast, including tissue and skin characteristics, also must be carefully considered. In particular, the failure to clinically select a breast implant of the appropriate volume and shape can lead to disappointing aesthetic results, potentially uncorrectable deformities, or even the need for re-operation. Re-operation, which generally occurs with a frequency of ten to twenty percent (10-20%) after three (3) years, not only unnecessarily exposes the patient to additional surgery, but is also costly in terms of both the additional surgical procedure itself and the replacement implants.

Given the wide range of patient goals and differing physical characteristics, a relatively large range of breast implants have been developed and marketed. (Counting types, sizes, shapes, and so on, over two hundred [200] different implants are available in the United States alone.) While this wide range of choices advantageously allows patients and doctors the flexibility to choose the appropriate implant, the array of choices can also make the decision process more complicated, for both patient and doctor.

Moreover, for reconstructive surgery after a mastectomy or other surgery removing all or part of the breast, appropriate tissue expanders may need to be employed prior to use of a breast implant. Again, an array of choices is available, and proper selection of a tissue expander is critical to success. Moreover, the tissue expander chosen must be compatible with the selected breast implant.

In other words, patients and their doctors need a better way of selecting the best possible breast implant and tissue expander from the relative large number of choices available in the marketplace. Any new breast implant selection techniques must not only address the aesthetic goals of the patient, but also the constraints imposed by the patient's physical characteristics. Such techniques should be accurate and minimize the risk of disappointing results and re-operation, yet still simplify the selection process.

### BRIEF DESCRIPTION OF THE DRAWINGS

FIG. 1 illustrates an example system for breast implant surgery planning, according to an example embodiment of the present invention.

FIG. 2 illustrates in more detail, the decision support components of the example system for breast implant surgical planning, according to an example embodiment of the present invention.

FIG. 3 illustrates an example input-output module interface screen, according to an example embodiment of the present invention.

FIG. 4 illustrates a flowchart of an example method for facilitating the planning of breast implant surgery, according to an example embodiment of the present invention.

### DETAILED DESCRIPTION OF EXAMPLE EMBODIMENTS

Some example embodiments of the present invention related to computer-assisted surgical planning systems, and more particularly to systems for planning breast implant surgery. These example embodiments may receive information on patient anatomy, for example measurements taken by a clinician or observations by a clinician, and also preference information indicating the goals of the surgery. Based on this information, as well as information on available implants and tissue expanders, the system may provide information indicating recommended implants and/or tissue expanders to the clinician.

One example embodiment of the present invention is apparatus for computer-assisted planning of breast implant surgery. The system may include an anatomical input module configured to receive anatomical information indicative of pre-implant anatomical properties of a patient's breast. The system may also include a preference module configured to receive preference information indicative of a desired post-implant anatomical property of a patent's breast. The system may also include a tissue expander selection module configured to receive the anatomical and the preference information, and, based at least in part on the anatomical and preference information, to output recommended expander information indicating at least one tissue expander from an available plurality of tissue expanders. The system may also include an implant selection module configured to receive the anatomical and the preference information, and, based at least in part on the anatomical and preference information, to output recommended implant recommendation information indicating at least one implant from an available plurality of implants.

Optionally the anatomical input module is configured to receive information indicative of at least one of breast type, breast volume, breast width, breast height, nipple to infra-mammary fold distance, sternal notch-nipple distance, intermammary distance, areola diameter, and amount of removed tissue. In one example, all of these features are used.

Optionally the anatomical input module is further configured to receive second anatomical information indicative of anatomical properties of a patient's second breast that is not to receive an implant. The tissue expander selection module and the implant selection module may both be configured to output recommendation information based at least in part on the second anatomical information.

Optionally, the system may include an implant incision planning module configured to receive the anatomical and preference information, and, based at least in part on the anatomical and preference information, to output information indicating a suggested location for an incision for an implant insertion procedure. Also, the system may include an expander incision planning module configured to receive the anatomical and preference information, and, based at least in part on the anatomical and preference information, to output information indicating a suggested location for an incision for an expander insertion procedure.

Optionally, in the example system the tissue expander selection module may further configured to receive the implant recommendation information, and to use the implant recommendation information in determining the tissue expander recommendation information. Alternatively, the implant selection module is further configured to receive the expander recommendation information, and to use the expander recommendation information in determining the implant recommendation information.

In the example embodiment, the information indicating at least one tissue expander from an available plurality of tissue expanders may be, for example, a tissue expander model identifier, a tissue expander width, a tissue expander height, a tissue expander, or a tissue expander fill. In example embodiment, the information indicating at least one implant from an available plurality of tissue implants may be, for example, an implant model identifier, an implant projection, an implant volume, or an implant width.

In some example embodiments, the implant selection module may be further configured to receive actual fill information indicative of the actual fill volume of a previously implanted tissue expander and to use said fill information in determining a recommended implant.

Some example embodiments may include or be linked to an anatomical data extraction module configured to extract the anatomical information from a digital image of the patient's breast. These example embodiments may also include an implant database. The implant database may store in a tangible medium implant information regarding the available breast implant models. In addition, a tissue expander database may store in a tangible medium information regarding the available tissue expander models. The tissue expander selection module may be configured to receive the expander information from the expander database and to use the expander information in determining the expander recommendation information; and the implant selection module may be further configured to receive the implant information from the implant database and to use the implant information in determining the implant recommendation information.

Another example embodiment of the present invention may include a method for computer-assisted planning of breast implant surgery. The example method may be performed using any of the example systems described herein, but may also be performed using other types of systems, for example internet computer servers, decision support systems, or expert systems. The example method may include receiving at an implant decision support system anatomical information indicative of pre-implant anatomical measurements of a patient's breast. The method may further include receiving at the implant decision support system preference information indicative of a desired post-implant anatomical property of a patient's breast. The method may further include, based on the anatomical measurements and the preference information, outputting with the implant decision support system expander information indicating at least one recommended tissue expander model from a plurality of available tissue expander models and implant information indicating at least one recommended implant model from a plurality of available implant models.

Optionally, in the example method, receiving the anatomical information may include receiving information indicative of at least one of breast type, breast volume, breast width, breast height, nipple to infra-mammary fold distance, sternal notch-nipple distance, intermammary distance, areola diameter, and amount of removed tissue. In some cases, all of these parameters may be used.

In some implementations of the example method, the method may further include receiving second anatomical information indicative of anatomical properties of a patient's second breast that is not to receive an implant. The output information indicating at least one recommended tissue expander model and at least one recommended implant model may be based at least in part on the second anatomical information.

In some example, the example method may further include, based at least in part on the anatomical and preference information, to outputting information indicating a suggested location for an incision for an implant insertion procedure and/or outputting a suggested location for an incision for an expander insertion procedure.

In the example method, the information indicating at least one tissue expander from an available plurality of tissue expanders may be, for example, a tissue expander model identifier, a tissue expander width, a tissue expander height, a tissue expander projection, or a tissue expander fill. The information indicating at least one implant from an available plurality of tissue implants may be, for example, an implant model identifier, an implant projection, an implant width, or an implant volume.

Optionally, in some example methods, the method may further include receiving actual fill information indicative of the actual fill volume of a previously implanted tissue expander; wherein said recommended tissue expander information is based at least in part on the actual fill information. In another option, the example method receiving a digital image of the patient's breast, and extracting the anatomical information from the digital image.

In some of the example methods, the method may further include retrieving tissue expander information from an expander database; retrieving implant information from an implant database. In these example methods, the tissue expander recommendation information may be based at least in part on the tissue expander information, and the implant recommendation information may be based at least in part on the implant information.

In some further example embodiments, a computer readable medium may be provided. The computer readable medium may have instructions stored thereon, the instructions being configured, so that when executed by a processor, to cause the performance one of the above example methods.

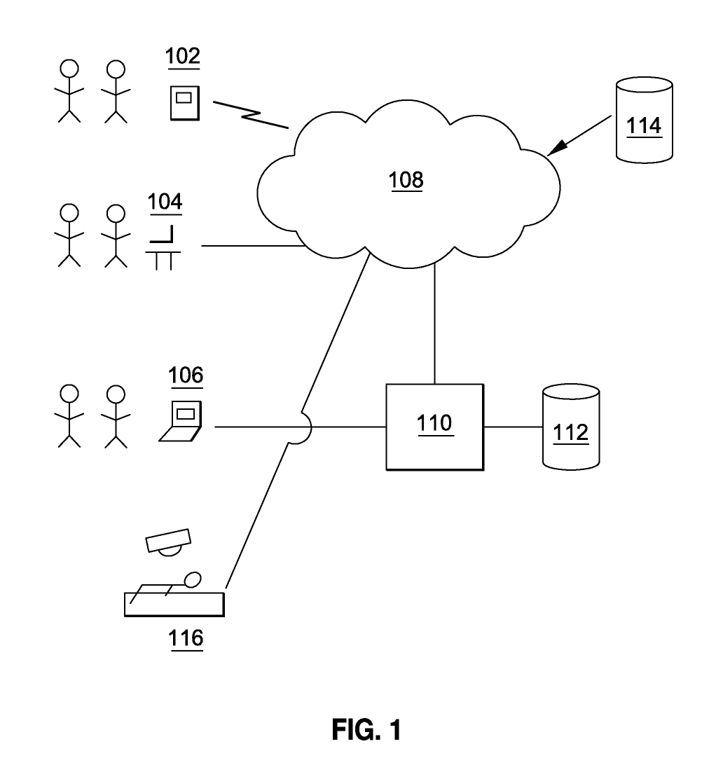

FIG. 1 illustrates an example system for breast implant surgical planning according to an example embodiment of the present invention. Clinicians, or clinicians working with patients, may interact with the system through a variety of approaches. For example, wireless device 102, such as an Apple iPad may connect the clinician with the system through a secure wireless communication channel. Laptop computer 104 connects the clinician to the system through a secure wired Internet connection via an Internet 108. Desktop computer 106 may be connected via a local area network. The decision support and processing capability may be provided in a variety of ways, for example using a computer server 110 with database 112. The server 110 may receive information from the clinicians and patients. The server 110 may also receive information regarding available breast implant and expander devices (or rules for deciding which devices to use) from database 112. Although, it will be appreciated that the information and rules may also be provided using other approaches, for example, hard coding them into a custom program, or using an expert system or decision support engine that allows programmable rules. It will be appreciated that the entire capability of the system could also be provided on the clinician's client device, for example as standalone software or as a browser plug in, or decision support functionality could be distributed in different manners. The system may also access patient medical information from other sources, for example a patient medical records database 114. The system may also receive digital test results, for example from an imaging device 116.

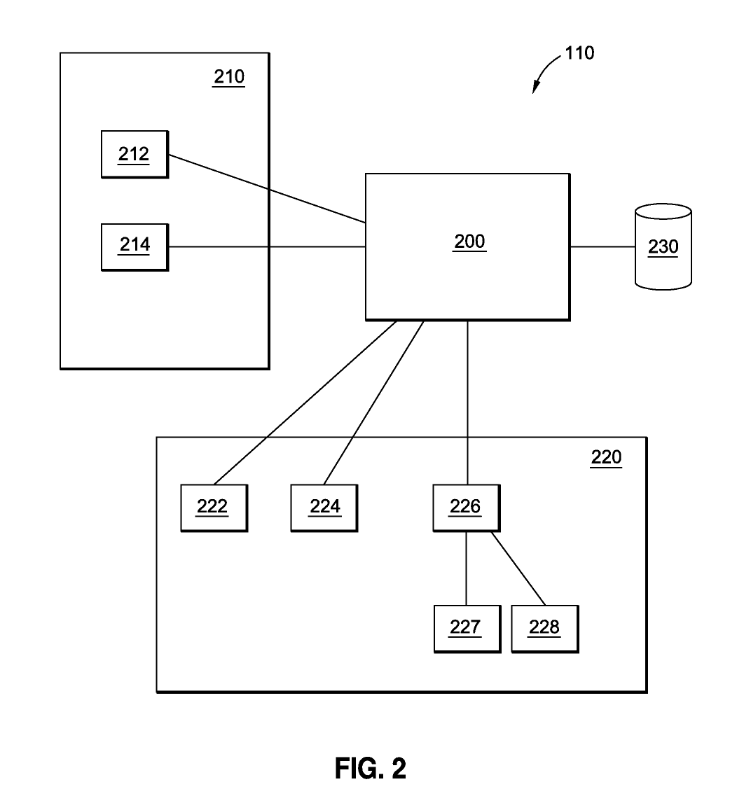

FIG. 2 illustrates in more detail, the decision support components of the example system for breast implant surgical planning, according to an example embodiment of the present invention. A processor 200 may coordinate the various components, process information from the various components, and execute code or rules received from the various components. An input-output component 210 may provide an interface to clinicians or other users, e.g., by providing web page services for sending and receiving information from a clinician's client device. The input components may include an anatomical information input module 212 for receiving information about the patient's anatomy. This anatomical information may include breast type (for example: very tight, tight, average, loose, very loose, or severe ptosis), breast volume, breast width, breast height, nipple to infra-mammary fold distance, sternal notch-nipple distance, intermammary distance, areola diameter, and amount of removed tissue from a prior mastectomy procedure or tissue expander implant procedure. The input-output components may also include a preference module 214 configured to receive information regarding patient and/or clinician preference—such as the desired breast size or type after surgery.

The processor may interact with a decision support system 220 that includes various component modules for making suggestions and recommendations based on collected data. These may be hard coded programs, expert systems, or rely on rules or ranges input from a device information database 230. A tissue expander selection module 222 may receive the patient anatomical and preference information, and based on that information may identify recommended tissue expanders. The recommended expander indication, such as a model identifier, or particular dimensions, may then be output to the clinician, for example using the input-output interface 210. For example, in one example embodiment, the following rules may be employed. First breast width is matched to the nearest tissue expander width for the available tissue expander models. The expander height may be moderate as a default, unless the clinician chooses to modify the desired outcome. The default projection may be variable, for consistent lower-pole fullness. It will be appreciated that additional rules may be added to create a more sophisticated recommendation.

An implant expander selection module 224 may receive the patient anatomical and preference information, and based on that information may identify recommended implants. The recommended implant indication, such as a model identifier, or particular dimensions, may then be output to the clinician, for example using the input-output interface 210. For a post-mastectomy procedure, the default may be a high profile implant because the expanded breast has little existing breast volume, thus requiring more projection. For augmentation, the default may be a midrange profile. This is done because the pre-augmentation breast will already have some existing breast volume.

Once the implant and tissue expander (if needed) have been selected, the dimensions may be illustrated graphically on a model torso display on the right hand side of the interface screen.

The example system may also include an incision planner 226, with sub modules for planning tissue expander incisions 227, and implant incisions 228.

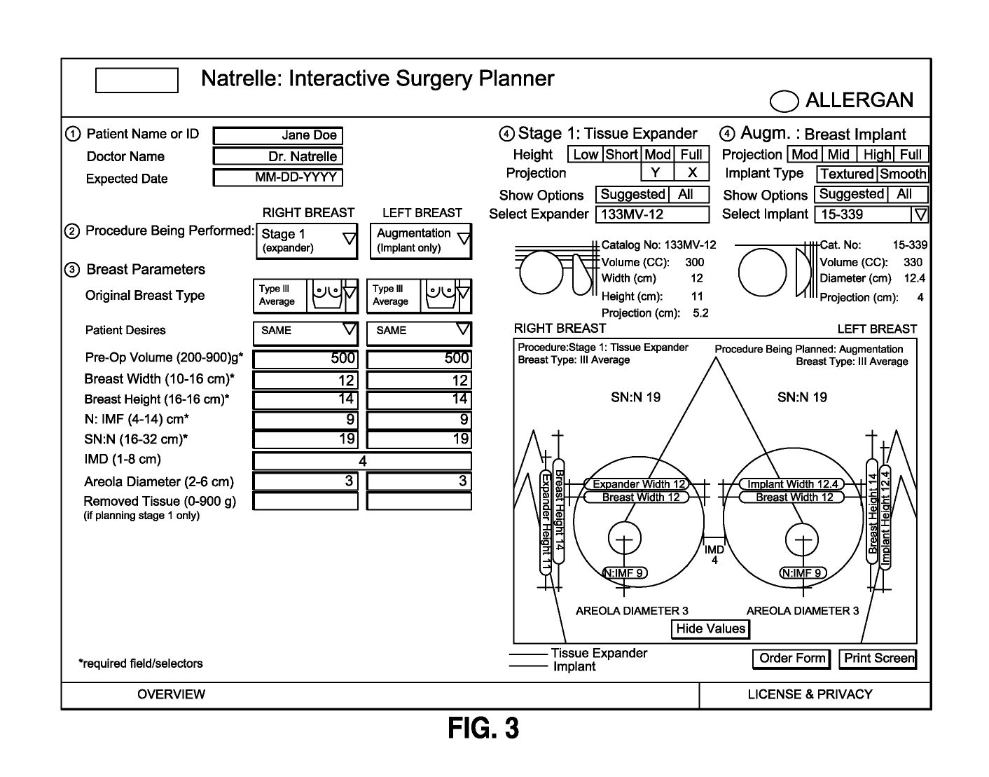

FIG. 3 illustrates an example input-output module interface screen, according to an example embodiment of the present invention. On the left hand side of the figure, there are various input fields that form an interface for the anatomical information input module 212. The clinician or their assistant can input information about the patient's existing breast or breasts. Also included is an input interface for the preference module, that allow the patient or clinician to specify a desired breast size or other breast characteristics, or in the case of a unilateral mastectomy, that the breast that is receiving an implant should be matched to the other breast.

In on example embodiment, allowed input ranges may be defined by the following table.

| | |
|---|---|
| Input | Acceptable Values |

Patient and Surgeon Parameters

| | |
|---|---|
| Patient Name or ID | Any string of characters |
| Doctor Name | Any string of characters |
| Expected Surgery Date | Any string of characters |

Procedure Parameters

| | |
|---|---|
| Procedure Being Planned | Select One From a |
| | Dropdown List: |
| | None |
| | Stage 1 (Tissue Expander Only) |
| | Stage 2 (Tissue Expander to |
| | Implant Exchange) |
| | Augmentation (Implant Only) |

Breast Parameters

| | |
|---|---|
| Breast Type | Select One From a |
| | Dropdown List: |
| | Type I (Very Tight) |
| | Type II (Tight) |
| | Type III (Average) |
| | Type IV (Loose) |
| | Type V (Very Loose) |
| | Severe Plosis |
| Patient Desires (Size) | Select One From a |
| | Dropdown List: |
| | Smaller |
| | Same |
| | Larger |
| Estimated Pre-Operative Volume | 200-900 grams |
| Breast Width | 10-16 cm |
| Breast Height | 6-16 cm |
| Nipple to Intramammary Fold (N:IMF) | 4-12 cm |
| Sternal Notch to Nipple (SN:N) | 16-32 cm |
| Intermammary Distance (IMD) | 1-8 cm |
| Areola Diameter | 2-6 cm |
| Removed Tissue* | 0-900 g |
| Expander Used* | Choose a NATRELLE ® |
| | Style 133 Tissue Expander from |
| | a Dropdown List or manually |
| | enter the dimensions for |
| | another tissue expander. |

*If planning Reconstruction Stage 1 or Stage 2

Breast width alone may be inadequate to determine the optimal volume to fill a patient's breasts; there must also be an assessment of the patient's breast type. In one example embodiment, the patient's breasts may be divided into five different breast types based upon the elasticity of the skin, amount of parenchyma, and characteristics of that parenchyma (e.g. glandular vs. fatty). Recording this information can help determine what type of implant projection the patient may want and need to achieve her desired outcome. To determine a patient's breast type, a quantitative assessment using the simple skin stretch (SS) may be the most accurate/objective method, but for surgeons with a large amount of experience with breast augmentation, who prefer a qualitative/subjective assessment, the breast type may be determined using the descriptors and pictures provided.

To perform the skin stretch (SS) assessment, the skin of the medial areola may be grasped and pulled maximally anteriorly (while holding a caliper to measure the amount of stretch). The calipers should measure the amount of stretch in centimeters (cm) from the resting plane of the areola to the stretched position.

The breast type may be determined based on the following parameters:

The primary assessment of breast type may be the skin stretch measurement (envelope characterization). The secondary assessment may be the fill of the breast. If the skin stretch is 2 cm or the surgeon feels the envelope is between average and tight (breast type III and II) the characterization of the fill may serve as a “tie-breaker.” Breast fill characteristics includes an assessment of the amount of breast tissue and also the character of the tissue (soft vs. glandular). The distribution of the parenchyma is also relevant as the more glandular/firm breast (FIG. 1) will have an even distribution of parenchyma throughout the breast with maintenance of upper pole fill. In the less glandular/less filled, empty breast the upper pole is less filled, with the fill more distributed to the lower breast.

A patient's breast width may be another factor for successful outcomes in selection of implants. In the example embodiment described here, it is intended that a patient's breast is measured at the level of the nipple as a linear measurement from the visible medial border of the breast mound to the visible lateral border of the breast mound in centimeters (cm). However, it will be appreciated that other approached for this and other measurements may be employed as long as they are used consistently.

On the right side of the interface screen the recommendation interface is illustrated. While any type of implants and tissue expanders may be used, the system is illustrated with Allergan Natrelle® implants and tissue expanders.

NATRELLE® tissue expanders and implants are available in a variety of heights, diameters and projections. The matrix of available implants will meet a variety of patient needs. Each NATRELLE® Style 133 tissue expander model is designated with two letters and is available in a range of base widths. Since NATRELLE® Style 144 tissue expanders are anatomical in shape, both height and width will vary by model. The first letter describes the implant's height (F for full, M for moderate, S for Short, or L for Low). The second letter describes the implant's projection (X for extra, or V for variable). Each NATRELLE® gel-filled breast implant has a base width (or diameter) and a projection. Each style of NATRELLE® gel-filled breast implant has its own diameter-to-projection ratio (Style 10 for Moderate, Style 15 for Midrange, Style 20 for High, Style 45 for Full).

The example implant recommendation interface and expander recommendation interface may show all dimensions of each tissue expander and implant, as well as visually draw the outline of each implant on the torso model. This should improve visualization and surgical planning. It will be appreciated that a particular implant or expander can be suggested, or a range of devices having dimensions in a particular range can be recommended. Alternatively, the system might simply recommend particular dimensions for an implant and allow the clinician to make their own choice based on the particular recommendation, although it is not expected that this would be a preferred mode of use for most clinicians.

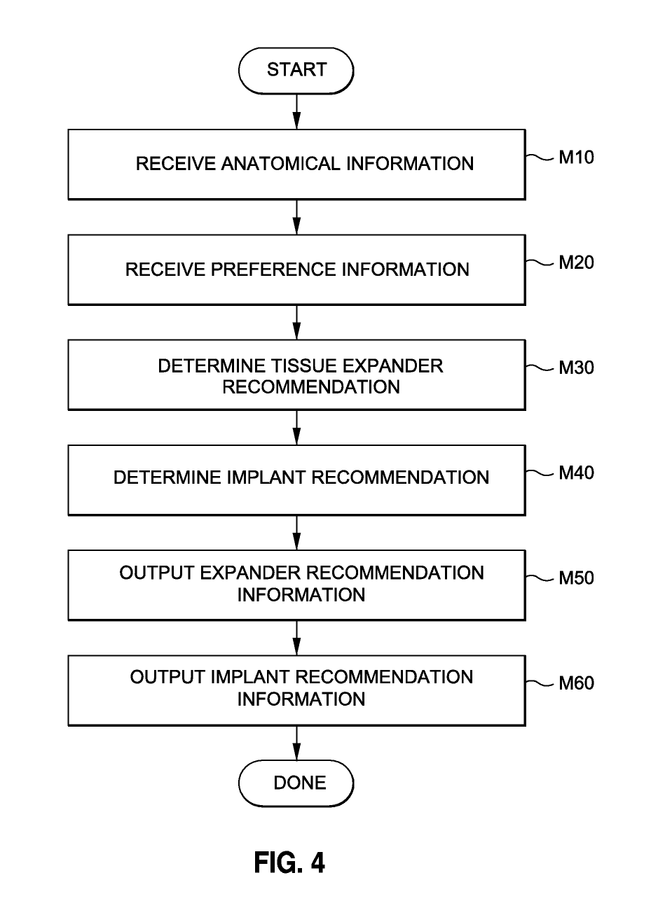

FIG. 4 illustrates a flowchart of an example method for facilitating the planning of breast implant surgery, according to an example embodiment of the present invention. It will be appreciated that this procedure may be performed by a decision support system, for example the system described previously in the present specification, although it is not limited to that particular system.

In M10, patient anatomical information may be received. This may be retrieved from patient medical records, extracted from patient imaging, or input by a clinician or their assistant at a user interface screen. This information may include various attributes of the patient's breast anatomy, such as breast type, breast volume, breast width, breast height, nipple to infra-mammary fold distance, sternal notch-nipple distance, intermammary distance, areola diameter, and amount of removed tissue. It may also include information about the patient's other breast, if the implant follows a unilateral mastectomy.

In one alternative system, some or all anatomical measurements may be extracted automatically, for example from imaging studies of a patient's breast. For example, methods described in U.S. Patent Application 2009/0181104 to Rigotti and Baroni, assigned to Allergan, Inc. may be employed to convert medical image data into anatomical measurements.

In M20, patient preference information may be received, for example whether the patient is seeking enlargement, decrease, or a particular amount of enlargement or decrease. Preference information post-unilateral mastectomy might also merely indicate that the post-operative breast is to be matched to the intact breast.

In M30, a tissue expander recommendation may be determined based on the patient preference and anatomical information, for example, using the rules described previously.

It will be appreciated that additional rules may also be added for more accurate and valuable recommendations.

In M40, an implant recommendation may be determined based on the patient preference and anatomical information, for example, using the rules described previously. It will be appreciated that additional rules may also be added for more accurate and valuable recommendations. For example, in some scenarios, where tissue expanders have variable fill, the actual fill of the tissue expander or other measurements related to the use of the tissue expander may be received and used in the selection of the implant.

In M50, the expander recommendation may be output, for example, by displaying it on a screen interface of a clinician's client device or web browser. The recommendation may be particular model or models of available expanders, or merely suggested dimensional ranges.

In M60, the implant recommendation may be output, for example, by displaying it on a screen interface of a clinician's client device or web browser. The recommendation may be particular model or models of available expanders, or merely suggested dimensional ranges.

Both the implant and expander recommendation information may also be displayed graphically, for example by showing dimensional information on a graphical display of a simulated or actual patient torso. If a clinician wants to explore various options, and look at altering the recommended implant or choosing between several recommendations, these may also be displayed.

It will be appreciated that all of the disclosed methods and procedures described herein can be implemented using one or more computer programs or components. These components may be provided as a series of computer instructions on any conventional, tangible computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

What is claimed is:

1. An apparatus for computer-assisted planning of breast implant surgery comprising:
an anatomical input module configured to receive anatomical information indicative of pre-implant anatomical properties of a patient's breast;
a preference module configured to receive preference information indicative of a desired post-implant anatomical property of a patent's breast;
a tissue expander selection module configured to receive the anatomical and the preference information, and, based at least in part on the anatomical and preference information, to output recommended expander information indicating at least one tissue expander from an available plurality of tissue expanders; and
an implant selection module configured to receive the anatomical and the preference information, and, based at least in part on the anatomical and preference information, to output recommended implant recommendation information indicating at least one implant from an available plurality of implants.

2. The apparatus of claim 1, wherein the anatomical input module is configured to receive information indicative of at least one of breast type, breast volume, breast width, breast height, nipple to infra-mammary fold distance, sternal notch-nipple distance, intermammary distance, areola diameter, and amount of removed tissue.

3. The apparatus of claim 1, wherein the anatomical input module is further configured to receive second anatomical information indicative of anatomical properties of a patient's second breast that is not to receive an implant.

4. The apparatus of claim 1, further comprising:
an implant incision planning module configured to receive the anatomical and preference information, and, based at least in part on the anatomical and preference information, to output information indicating a suggested location for an incision for an implant insertion procedure.

5. The apparatus of claim 1, further comprising:
an expander incision planning module configured to receive the anatomical and preference information, and, based at least in part on the anatomical and preference information, to output information indicating a suggested location for an incision for an expander insertion procedure.

6. The apparatus of claim 1, wherein the tissue expander selection module is further configured to receive the implant recommendation information, and to use the implant recommendation information in determining the tissue expander recommendation information.

7. The apparatus of claim 1, wherein the implant selection module is further configured to receive the tissue expander recommendation information, and to use the tissue expander recommendation information in determining the implant recommendation information.

8. The apparatus of claim 1, wherein the information indicating at least one tissue expander from an available plurality of tissue expanders is a tissue expander width.

9. The apparatus of claim 1, wherein the implant selection module is further configured to receive actual fill information indicative of the actual fill volume of a previously implanted tissue expander and to use said fill information in determining a recommended implant.

10. The apparatus of claim 1, further comprising an anatomical data extraction module configured to extract the anatomical information from a digital image of the patient's breast.

11. A method for computer-assisted planning of breast implant surgery, comprising:
receiving at an implant decision support system anatomical information indicative of pre-implant anatomical measurements of a patient's breast;
receiving at the implant decision support system preference information indicative of a desired post-implant anatomical property of a patient's breast; and
based on the anatomical measurements and the preference information, outputting with the implant decision support system expander information indicating at least one recommended tissue expander model from a plurality of available tissue expander models and implant information indicating at least one recommended implant model from a plurality of available implant models.

12. The method of claim 11, wherein receiving the anatomical information includes receiving information indicative of at least one of breast type, breast volume, breast width, breast height, nipple to infra-mammary fold distance, sternal notch-nipple distance, intermammary distance, areola diameter, and amount of removed tissue.

13. The method of claim 11, further comprising:
receiving second anatomical information indicative of anatomical properties of a patient's second breast that is not to receive an implant.

14. The method of claim 13, wherein the output information indicating at least one recommended tissue expander model and at least one recommended implant model is based at least in part on the second anatomical information.

15. The method of claim 11, further comprising:
based at least in part on the anatomical and preference information, outputting information indicating a suggested location for an incision for one of an implant insertion procedure or a tissue expander insertion procedure.

16. The method of claim 11, further comprising:
receiving actual fill information indicative of the actual fill volume of a previously implanted tissue expander;
wherein said recommended tissue expander information is based at least in part on the actual fill information.

17. The method of claim 11, further comprising:
receiving a digital image of the patient's breast; and
extracting the anatomical information from the digital image.

18. The method of claim 11, further comprising;
retrieving tissue expander information from a tissue expander database;
retrieving implant information from an implant database;
wherein the tissue expander recommendation information is based at least in part on the tissue expander information, and wherein the implant recommendation information is based at least in part on the implant information;

19. An article of manufacture comprising a computer readable medium having instructions stored thereon, the instructions being configured, so that when executed by a processor, to cause the performance of the method of claim 11.
